(19) United States
(12) Patent Application Publication
(10) Pub. No.: US 2006/0273764 A1
(43) Pub. Date: Dec. 7, 2006

(54) METHOD AND CHARGING APPARATUS CONTROLLED BY COMPUTER FOR CONVERTING INPUT POWER INTO REQUIRED CHARGING VOLTAGE AND CHARGING CURRENT

(76) Inventor: Jen-Yuan Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/419,197

(22) Filed: May 18, 2006

(30) Foreign Application Priority Data
Jun. 1, 2005 (TW) 094117996

(51) Int. Cl. H02J 7/04

(52) U.S. Cl. 320/151

(57) ABSTRACT

A charging apparatus includes a control unit and a power converter. The control unit is used for generating a power control signal according to an input signal to adjust charging power. The power converter is electrically connected to the control unit, for converting input power into charging power, wherein the input signal is determined in accordance with a computer.

### BACKGROUND OF THE INVENTION

1. Field of the Invention

The present invention relates to a charging apparatus and a charging method, and more especially, to a charging apparatus and a charging method for converting input power into required charging voltage and charging current via hardware or software interfaces controlled by a computer to proceed charging procedures.

2. Description of the Prior Art

A current trend, and objective, of electronic devices, especially their physical attributes, is moving towards light weight and slim proportions, more and more portable electronic devices are designed for using at anytime and anywhere. To achieve this objective, it is obviously that these portable electronic devices have to use batteries as their power source. When the power of the batteries is exhausted, users have to proceed by performing a number of battery charging procedures to the batteries for replenishing power of the batteries.

Unfortunately, the electrical specifications of these portable electronic devices are different from each other, therefore, the requirements of the charging power is also different when the battery is under a condition of being charged. For example, the charging voltage value and the charging current value of the battery in the mobile phone are different from the charging voltage value and the charging current value of the battery in the MP3 player. Even though all are mobile phones, different brands have different charging specification. If the battery is charged with a charging voltage and a charging current that are lower than the specification values, the battery cannot be filled with power through the charging procedures. On the other hand, if the battery is charged with a charging voltage and a charging current those are higher than the specification values, and then the charging process may damage the battery or the circuits in the electronic device, causing the life time of the battery and the electronic device to be reduced. In a much more serious scenario, it is possible that incorrect battery charging will result in dangers leading to a battery explosion or a fire.

In general, a lot of portable electronic devices attach to an exclusive charging device, therefore, users can use the exclusive charging device for recharging of the spent battery. However, this procedure is very inconvenient for users. Considering the practical circumstances of this recharging process, when users take several different electronic devices (such as mobile phones, MP3 players, and personal data assistants (PDAs)), because each and every portable electronic device has its own corresponding charging specifications, the users will have to bring several different charging devices for proceeding charging procedures to the batteries used in the different electronic devices. Besides, users need to be careful to avoid an unexpected danger caused by using incorrect wrong charging device while charging the battery of any of the several different electronic devices.

### SUMMARY OF THE INVENTION

It is therefore an objective of the claimed invention to provide a charging apparatus and a charging method for converting input power into required charging voltage and charging current via hardware or software interfaces controlled by a computer to proceed charging procedures. The claimed invention is able to provide suitable charging voltages and charging currents to batteries used in a variety of different electronic devices, to solve the above-mentioned problems.

According to an embodiment of the claimed invention, a charging apparatus is disclosed. The charging apparatus includes: a control unit for generating a power control signal according to an input signal; and a power converter electrically connected to the control unit for converting an input power into a charging power, wherein the input signal is determined by a computer, and voltage values and current values of the charging power are set by the power control signal.

According to another embodiment of the claimed invention, a method for controlling a charging status is disclosed. The method includes: generating a power control signal according to an input signal; and converting an input power into a charging power, wherein the input signal is determined by a computer, and voltage values and current values of the charging power are set by the power control signal.

The apparatus and method disclosed in the claimed invention apply a ready power to be an input power, and then adjust a power converter through a control signal that is capable of being set by users for converting the input power into a charging power required by users. Therefore, the claimed invention, the charging apparatus, is able to provide suitable charging voltage and charging current according to specifications of different rechargeable batteries. In other words, for different batteries, users need only to simply provide the suitable charging information through an input interface to correctly process charging procedures with the rechargeable battery in an electrical devices via utilizing the claimed charging apparatus.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a charging apparatus according to a first embodiment of the present invention.

FIG. 2 is a block diagram of a charging apparatus according to a second embodiment of the present invention.

FIG. 3 is a flowchart of the method for controlling a charging status an embodiment of the present invention.

### DETAILED DESCRIPTION

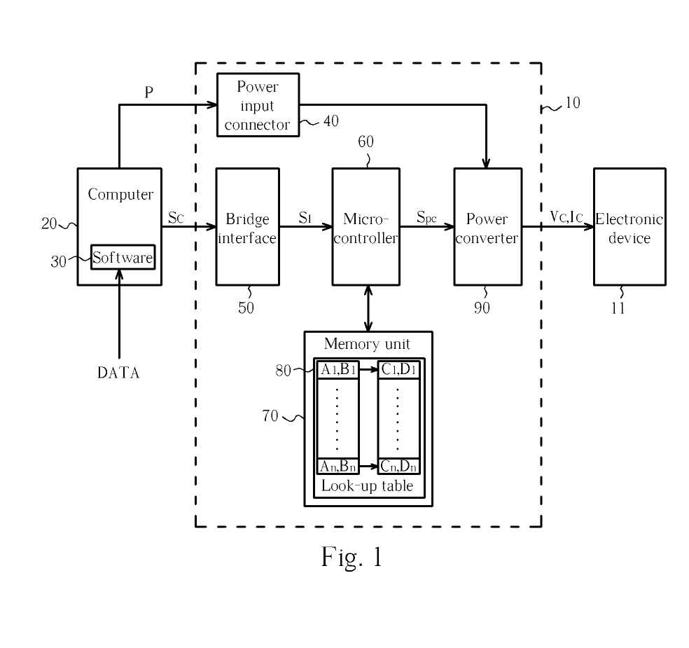

Please refer to FIG. 1. FIG. 1 is a block diagram of a charging apparatus 10 according to a first embodiment of the present invention. In this embodiment, the charging apparatus 10 includes a bridge interface 50, a power input connector 40, a micro-controller 60, a memory unit 70, and a power converter 90. Additionally, the charging apparatus 10 is electrically connected to a computer 20 via the power input connector 40 and the bridge interface 50. There is software 30 installed in the computer 20 to provide a human-machine interface such that users can input data related to the charging status, for example, users are able to provide information about the brand or the type of the electronic device 11 (e.g., the device includes rechargeable batteries) to the charging apparatus 10. A look-up table 80 is established in the memory unit 70 for recording corresponding relationships between hardware information and charging specifications of electronic devices in different brands and types. Alternatively, the corresponding relationships are also approved to be stored in the software installed in the computer. Please note that, in this embodiment, the charging specification stored in the look-up table 80 includes two pieces of information: the charging voltage and the charging current. As shown in FIG. 1, the look-up table 80 includes two storage sections; one is applied to record the hardware information of the electronic devices, that is, brands A₁-Aₙ and types B₁-Bₙ; the other is applied to record the charging specifications of the electronic devices, that is, values of charging voltage C₁-Cₙ and values of charging current D₁-Dₙ. The detailed operations and procedures are discussed in the following paragraphs.

In the beginning, users are able to input data DATA (for example, the hardware information about the brand and the type of the electronic device 11) through the utilization of the software 30 installed in the computer 20. Next, the software 30 transfers the data DATA into a control signal S_{C}, and then further transfers the control signal S_{C} into an input signal Sₗ, which is acceptable by the micro-controller 60 via the bridge interface 50. Finally, the micro-controller 60 processes a predetermined calculation in accordance with the input signal Sₗ for determining the charging voltage and the charging current required by the charging procedures of the electronic device, and generates a desired power control signal S_{PC} to control the power converter 90. As FIG. 1 shows, the charging apparatus 10 derives input power P from the computer 20 through the power input connector 40 and inputs the input power into the power converter 90. Furthermore, the power input connector 40 is also capable of deriving input power P from an outside power source (for example, an outer power supplier) and inputs the input power into the power converter 90. The power converter 90 converts the input power P into a suitable charging voltage V_{C} and a suitable charging current I_{C} in accordance with the power control signal S_{PC} to charge the batteries in the electronic device 11.

Please note that, the acceptable data DATA inputted by users can be any information about the charging status. For example, the data DATA indicates the brand A₁ and the type B₁ of the electronic device 11, therefore, the data DATA inputted by users is transferred into the control signal S_{C} by the computer 20 and then being transferred into the input signal Sₗ again by the bridge interface 50. In other words, the input signal Sₗ transmits the information about the brand A₁ and the type B₁ into the micro-controller 60, then the micro-controller 60 refers to the look-up table 80 stored in the memory unit 70 according to the information provided by the input signal Sₗ. Therefore, the micro-controller 60 knows that the required values of the charging voltage and the charging current are C₁ and D₁ respectively according to the look-up table 80. Next, the micro-controller 60 refers to the information about the charging status to generate the power control signal S_{PC} and inputs the power control signal S_{PC} into the power converter 90 to drive the power converter 90 converting the input power P into a suitable charging voltage V_{C} and a suitable charging current I_{C}. Additionally, users can directly set the charging voltage V_{C} and the charging current I_{C} through utilization of an input interface provided by the software 30. Given the condition that the user directly sets V_{C} and I_{C}, the predetermined calculation processed by the micro-controller 60 is just transferring the input signal Sₗ into the power control signal S_{PC}, which is acceptable by the power converter 90, that is, it is not necessary for the micro-controller 60 to access the look-up table 80 stored in the memory unit 70 to set the charging voltage V_{C} and the charging current I_{C}.

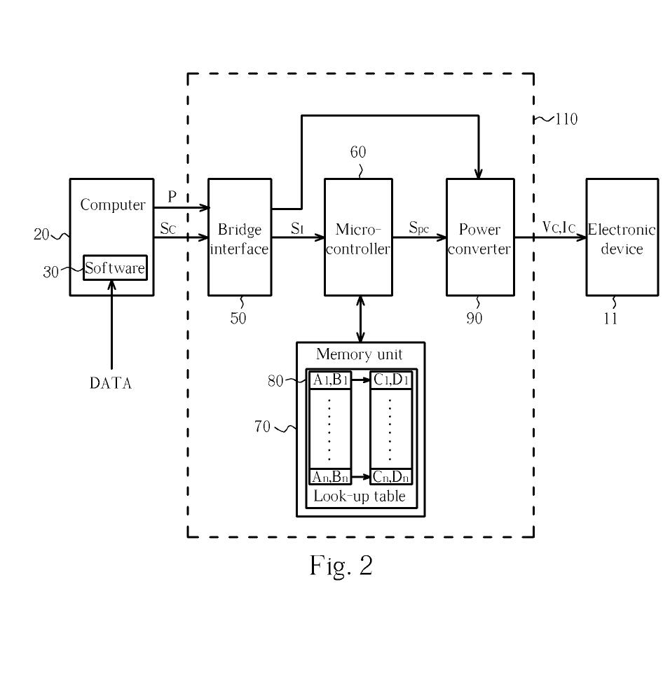

In the embodiment, well-known re-writable memory cells construct the memory unit 70; therefore, users are able to change the relationships of the look-up table 80 stored in the memory unit 70. For example, users can input a set of new relationships corresponding between brands and charging specifications through utilization of the software 30, the corresponding relationships are transmitted from the computer 20 to the micro-controller 60 via the bridge interface 50, and the micro-controller 60 saves the corresponding relationships into the look-up table 80 in the memory unit 70. A more efficient method is that, the computer 20 links to the provider of the charging apparatus 10 through the Internet. In this case, the provider regularly updates the corresponding relationships to be stored in the look-up table 80. Users just have to click various icons displayed on the computer screen to download and update data. Given this scenario, it is unnecessary to input data by keying a list of corresponding relationships. Besides, it is possible to increase an adjusting switch (not illustrated in FIG. 1 or FIG. 2) on the charging apparatus 10, 110 to realize the function of fixing the charging voltage through setting the adjusting switch.

All of the above-mentioned signals are transmitted from the computer 20 into the charging apparatus 10 and carried by a general communication interface of the computer 20, such as the well-known universal serial bus (USB), IEEE 1394 interface, or RS-232 serial port, etc. It is therefore noted that the bridge interface 50 in the charging apparatus 10 must be the universal serial bus (USB), IEEE 1394 interface, or RS-232 serial port corresponding to the computer 20. These standard interfaces all support power pins for outer connecting devices, so the power pins of the bridge interface 50 are also applied to provide the input power P for the charging apparatus 10. Please refer to FIG. 2. FIG. 2 is a block diagram of a charging apparatus 110 according to a second embodiment of the present invention. In this embodiment, the input power P is directly transmitted from the bridge interface 50 to the power converter 90. Consequently, it is an improvement for the charging apparatus 110 in both cost and size due to the fact that the power input connector 40 is eliminated.

For the charging apparatus 110 illustrated in the FIG. 2, although it is economized in cost and size through receiving the control signal S_{C} and the input power P from the computer 20 together by the bridge interface 50, one who skilled in the art will know that the power supported by the above-mentioned communication interfaces (such as USB, IEEE 1394, and RS-232 serial port) each has a maximum capability provided via the power pin. Therefore, if the batteries in the electronic device 11 require higher charging voltage V_{C} or higher charging current I_{C}, the power converter 90 in the charging apparatus 110 cannot provide sufficient input power P from the computer 20 through the bridge interface 50 to generate the required charging voltage V_{C} and the required charging current I_{C}. That is, the range of charging voltage and charging current provided by the charging apparatus 110 is small. For the charging apparatus 10 illustrated in the FIG. 1, it is capable of gathering sufficient power from the computer 20 because it has an individual power input connector 40. Therefore, if the batteries in the electronic device 11 require higher charging voltage V_{C} or higher charging current I_{C}, the power converter 90 in the charging apparatus 110 is still able to gather and supply sufficient input power P directly from the computer 20 via the power input connector 40 to generate the required charging voltage V_{C} and the required charging current I_{C}. The cost and size of the charging apparatus 10 are increased due to the power input connector 40, however, as compared to the charging apparatus 110, the range of charging voltage and charging current provided by the charging apparatus 10 is greater than the range that is supported by the charging apparatus 110. Users can choose one of the charging apparatuses 10, 110 according to specific requirements.

Please note that, the charging apparatuses 10, 110 can be an independent product outside the computer 20, for example, the charging apparatuses 10, 110 are portable devices outside of the computer 20 and connecting to the computer 20 via a power line or a transmission line. However, the charging apparatuses 10, 110 can also be integrated with the computer 20 (for example, a notebook computer) such that the computer 20 has the ability to charge other electronic devices. For instance, the charging apparatus 110 is directly integrated with a motherboard on the same printed circuit board (PCB). Meanwhile, there is a charging port positioned on the housing of the computer 20, and the power converter 90 connects to the electronic device 11 that requires an electrical charge through the charging port. If the bridge interface 50 is a PCI interface, then the charging apparatus 110 receives the control signal S_{c} and the input power P through the PCI interface in the computer 20. Furthermore, the charging apparatuses 10, 110 are also allowed to be produced as general add-on cards, so it is possible to insert the add-on cards into a slot on the motherboard that is installed in the computer 20 or be connected individually with the housing of the computer 20. If the above-discussed slot is a PCI slot and the bridge interface 50 of the charging apparatus 110 is also a PCI interface, then the charging apparatus 110 receives the control signal S_{c} and the input power P through the PCI interface in the computer 20. Additionally, if the above-discussed slot is a PCI slot and the bridge interface 50 of the charging apparatus 10 is also a PCI interface, the charging apparatus 10 can further include a power input connector 40, electrically connected to the output of the power supplier in the computer 20 to gather the required input power P. At the same time, the charging apparatus 10 receives the control signal S_{c} from the computer 20 through the PCI interface.

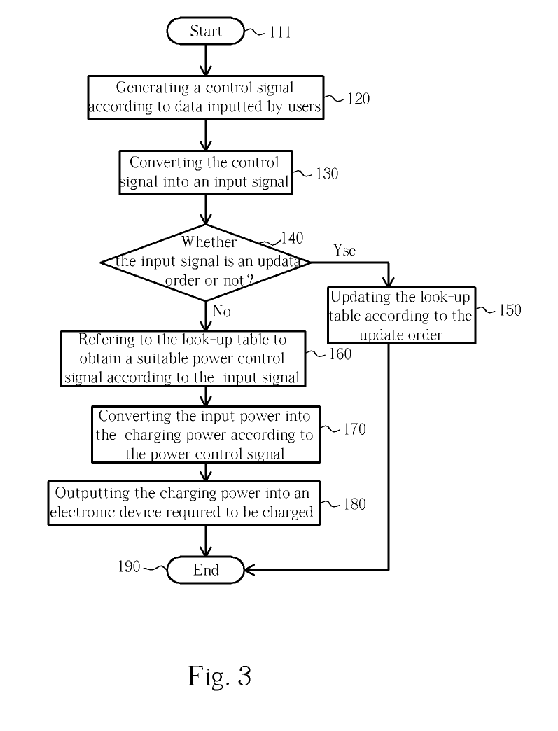

Please refer to FIG. 3. FIG. 3 is a flowchart of the method for controlling a charging status of the present invention. As shown in FIG. 3, the method for controlling the charging status of the present invention includes following steps:

step 111: start;

step 120: users input data through software installed in a computer, and the computer generates a control signal according to the inputted data;

step 130: the control signal is transferred into an input signal through a bridge interface;

step 140: a micro-controller determines whether the input signal is an update order or not, if the input signal is an update order, proceeding step 150; if the input signal is not an update order, proceeding step 160;

step 150: the micro-controller accesses a memory unit, and updates a look-up table stored in the memory unit according to the update order, wherein the look-up table records the corresponding relationships between the input data and the charging voltage and the charging current, jumping to step 190;

step 160: the micro-controller refers to the look-up table stored in the memory unit according to the input signal, and obtains a suitable power control signal according to the corresponding relationship between the input data and the charging voltage and the charging current recorded in the look-up table;

step 170: a power converter converts input power into corresponding charging voltage and charging current in accordance with the power control signal;

step 180: outputting the charging voltage and the charging current to the electronic device required to be charged;

step 190: end.

Comparing with related arts, the charging apparatus and the control method thereof apply a ready power to be the input power, and adjust the power converter through the control signal set by users to convert the input power into the required charging power. Consequently, the charging apparatus disclosed in the present invention provides suitable charging voltage and charging current according to specifications of different rechargeable batteries. In other words, for different batteries, users just have to provide correct charging information (such as brands and types) via an input interface, then the charging apparatus disclosed in the present invention is able to process the charging procedures correctly for the rechargeable batteries in the electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A charging apparatus comprises:
a control unit for generating a power control signal according to an input signal; and
a power converter electrically connected to the control unit for converting an input power into a charging power, wherein voltage values and current values of the charging power are set by the power control signal.

2. The apparatus of claim 1, wherein the control unit is a micro controller, for processing a predetermined calculation in accordance with the input signal to generate the power control signal.

3. The apparatus of claim 2, further comprising:
a memory unit, electrically connected to the micro controller, for storing a comparison table, wherein the predetermined calculation is referring to the comparison table in accordance with the input signal.

4. The apparatus of claim 2, further comprising:
a bridge interface, electrically connected to the micro controller, for receiving a control signal and transferring the control signal into the input signal.

5. The apparatus of claim 4, wherein the computer comprises software to be an input interface for receiving a data, and the computer generates the control signal according to the data.

6. The apparatus of claim 4, wherein the bridge interface further receives the input power from the computer.

7. The apparatus of claim 4, being integrated on an add-on card and capable to be positioned on a housing of the computer.

8. The apparatus of claim 4, further comprising:
a power input connector, electrically connected to the power converter, for receiving the input power providing outside the computer.

9. The apparatus of claim 4, being a portable device that is capable to be connected with the computer.

10. The apparatus of claim 4, wherein the bridge interface is a universal serial bus (USB), an IEEE 1394 interface, or an RS-232 serial port.

11. The apparatus of claim 1, being integrated on a motherboard in a computer.

12. A method for controlling a charging status, the method comprises:
generating a power control signal according to an input signal; and
converting an input power into a charging power, wherein voltage values and current values of the charging power are set by the power control signal.

13. The method of claim 12, further comprising:
storing a comparison table;
wherein the step for generating the power control signal further comprising:
generating the power control signal through referring to the comparison table in accordance with the input signal.

14. The method of claim 12, further comprising:
receiving a control signal from a computer and transferring the control signal into the input signal.

15. The method of claim 14, further comprising:
installing a software in the computer to be an input interface for receiving a data, and generating the control signal according to the data.

16. The method of claim 14, wherein the control signal is received by a universal serial bus (USB), an IEEE 1394 interface, or an RS-232 serial port.

17. The method of claim 12, wherein the input power is received by a universal serial bus (USB), an IEEE 1394 interface, or an RS-232 serial port.
